(19) United States
(12) Patent Application Publication
(10) Pub. No.: US 2006/0080128 A1
(43) Pub. Date: Apr. 13, 2006

(54) System and method for providing customized employment interviews

(75) Inventors: Michael L. Brown, Waxahachie, TX (US); Robert J. Landis, Midlothian, TX (US)

Correspondence Address: DOCKET CLERK, P.O. DRAWER 800889, DALLAS, TX, 75380, US

(73) Assignee: SkillsNET Corporation, Waxahachie, TX (US)

(21) Appl. No.: 11/237,627

(22) Filed: Sep. 28, 2005

Related U.S. Application Data
(60) Provisional application No. 60/614,319, filed on Sep. 29, 2004.

(51) Int. Cl. G06Q 99/00

(52) U.S. Cl. 705/1

(57) ABSTRACT

A method, system, and computer program receive an identification of one or more skills associated with a job. The method, system, and computer program also receive a selection of one or more questions associated with the one or more skills. In addition, the method, system, and computer program provide an interview form, which includes the selected questions for use during an employment interview.

### CROSS-REFERENCE TO RELATED APPLICATIONS

This application claims priority under 35 U.S.C. § 119(e) to U.S. Provisional Patent Application No. 60/614,319 filed on Sep. 29, 2004, which is hereby incorporated by reference.

### TECHNICAL FIELD

This disclosure relates generally to human resource management systems and more specifically to a system and method for providing customized employment interviews.

### BACKGROUND

An employment interview is an important tool for learning the capabilities, experience, and interests of candidates for employment. The interviewer who conducts an employment interview often needs considerable skill and knowledge in order to efficiently conduct the employment interview. Lots of information often needs to be obtained from a prospective new employee in a relatively short amount of time. If the interviewer does not ask proper questions or does not obtain necessary information, the employment interview may be of little value.

### SUMMARY

This disclosure provides an improved system and method for providing customized employment interviews.

In one aspect, a method, system, and computer program receive an identification of one or more skills associated with a job. The method, system, and computer program also receive a selection of one or more questions associated with the one or more skills. In addition, the method, system, and computer program provide an interview form, which includes the selected questions for use during an employment interview.

In a particular aspect, the method, system, and computer program receive an identification of one or more performance attributes associated with the one or more identified skills. The method, system, and computer program then provide a plurality of questions associated with the one or more identified performance attributes. In another particular aspect, the method, system, and computer program allow a user to tailor one or more of the selected questions.

Other technical features may be readily apparent to one skilled in the art from the following figures, descriptions, and claims.

### BRIEF DESCRIPTION OF DRAWINGS

For a more complete understanding of this disclosure, reference is now made to the following description, taken in conjunction with the accompanying drawings, in which:

FIG. 1 illustrates an example system for providing customized employment interviews according to one embodiment of this disclosure;

FIG. 2 illustrates an example input screen for identifying a job to be interviewed according to one embodiment of this disclosure;

FIG. 3 illustrates an example input screen for specifying applicant requirements for a job to be interviewed according to one embodiment of this disclosure;

FIG. 4 illustrates an example input screen for identifying skills required for a job to be interviewed according to one embodiment of this disclosure;

FIG. 5 illustrates an example input screen for selecting an identified skill required for a job to be interviewed according to one embodiment of this disclosure;

FIG. 6 illustrates an example input screen for selecting performance attributes associated with a skill required for a job to be interviewed according to one embodiment of this disclosure;

FIG. 7 illustrates an example input screen for selecting questions associated with a skill required for a job to be interviewed according to one embodiment of this disclosure;

FIG. 8 illustrates an example input screen for customizing questions associated with a skill required for a job to be interviewed according to one embodiment of this disclosure;

FIG. 9 illustrates an example scoring sheet for scoring an interview candidate according to one embodiment of this disclosure;

FIG. 10 illustrates an example method for providing customized employment interviews according to one embodiment of this disclosure; and

FIG. 11 illustrates an example method for scoring an interview candidate according to one embodiment of this disclosure.

### DETAILED DESCRIPTION OF EXAMPLE EMBODIMENTS

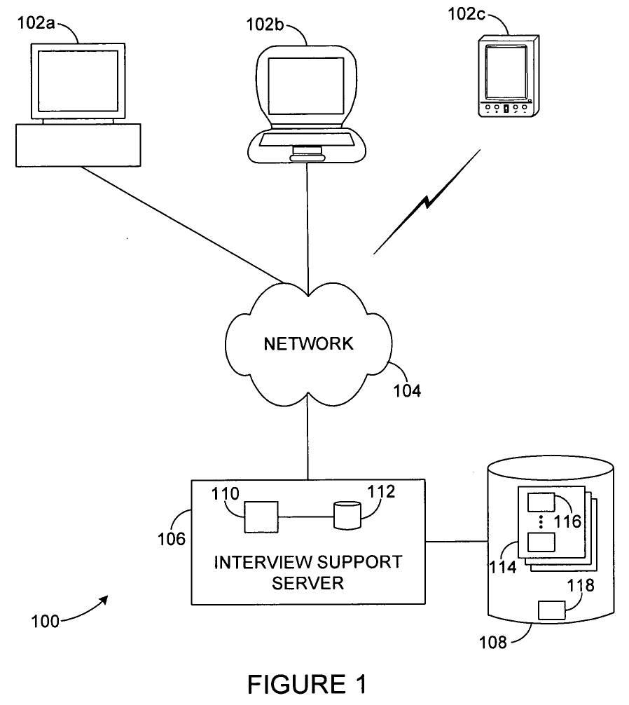

FIG. 1 illustrates an example system 100 for providing customized employment interviews according to one embodiment of this disclosure. In the illustrated example, the system 100 includes multiple user devices 102a-102c, a network 104, an interview support server 106, and a database 108. Other embodiments of the system 100 may be used without departing from the scope of this disclosure.

In one aspect of operation, a user uses one of the user devices 102a-102c (referred to as “user devices 102”) to access the interview support server 106. Using information from the user, the interview support server 106 provides the user with a list of questions, which may be used during an employment interview. The interview support server 106 also allows the user to print forms for use during an employment interview, such as questionnaires containing the questions. In addition, the interview support server 106 receives scores related to actual interviews, generates overall interview scores, and ranks job applicants. In this way, the interview support server 106 allows a user to customize an interview for a particular job opening and provides a mechanism for ranking applicants who have been interviewed.

In the illustrated embodiment, each user device 102 is capable of communicating with the network 104. In this document, the term “each” refers to each of at least a subset of the identified items. Each user device 102 represents any suitable device, system, or portion thereof that allows a user to communicate and interact with the interview support server 106. For example, a user device 102 allows a user to access the interview support server 106 and identify the type of job to be interviewed. The user device 102 also allows the user to identify various skills required for the job to be interviewed and to select questions to be asked during an employment interview.

In this particular example, the user devices 102 include a desktop computer, a laptop computer, and a personal digital assistant. Each of these user devices 102 communicates over a wireline or wireless connection. These user devices 102 are for illustration only. Any other or additional computing or communication devices may be used in the system 100. Each user device 102 includes any hardware, software, firmware, or combination thereof for accessing the interview support server 106.

The network 104 is capable of communicating with the user devices 102 and the interview support server 106. The network 104 facilitates communication between components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

The interview support server 106 is coupled to the network 104 and the database 108. In this document, the term “couple” and its derivatives refer to any direct or indirect communication between two or more elements, whether or not those elements are in physical contact with one another. The interview support server 106 supports the customization of employment interviews. For example, the interview support server 106 receives an identification of the job to be interviewed from a user. The interview support server 106 allows the user to select various skills needed for the job to be interviewed. The interview support server 106 also allows the user to identify various attributes associated with the selected skills. The interview support server 106 further allows the user to select and tailor various questions associated with the selected skills and attributes. The selected questions may then be used during employment interviews. In addition, after the interviews have been conducted, the interview support server 106 allows users to provide scores for job applicants and generates overall scores for the job applicants.

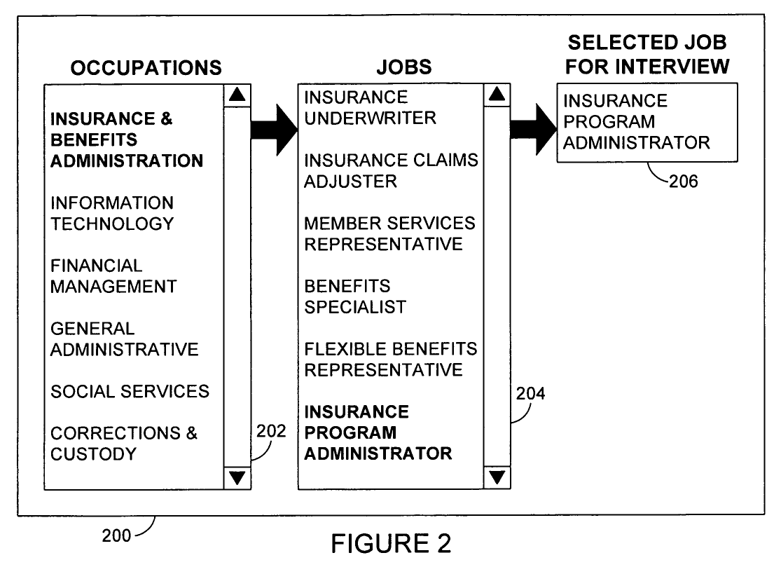

The interview support server 106 includes any hardware, software, firmware, or combination thereof for providing customized employment interview questions. As a particular example, the interview support server 106 could include one or more processors 110 and one or more memories 112 containing data and instructions used by the one or more processors 110. Also, the interview support server 106 receives input from users in any suitable manner, such as through the use of a web-based interface. Example mechanisms for receiving user input are shown in FIGS. 2-8, which are described below.

The database 108 is coupled to the interview support server 106. The database 108 stores various information used by the interview support server 106 to provide the customized employment interviews. In this example, the database 108 includes a library of skill sets 114. Each skill set 114 is associated with a different skill that may be required by applicants for a job opening. Each skill set 114 includes one or more question sets 116. Each question set 116 contains questions related to a particular attribute or aspect of the associated skill. In addition, the database 108 includes scores 118 associated with job applicants who have been interviewed. The database 108 includes any hardware, software, firmware, or combination thereof for storing and facilitating retrieval of information. The database 108 uses any of a variety of data structures, arrangements, and compilations to store and facilitate retrieval of information.

In one aspect of operation, a user indicates that a particular skill is required by applicants for a job opening. The interview support server 106 identifies the skill set 114 that is associated with the identified skill. The user then selects various attributes or aspects associated with the selected skill. The interview support server 106 identifies the question sets 116 associated with the selected attributes. The interview support server 106 provides the questions in the identified question sets 116 and allows the user to select and tailor those questions. The interview support server 106 then generates interview questionnaires or other forms containing the selected questions or other information provided by the user. In this way, the user customizes an employment interview for a particular job opening.

In particular embodiments, the database 108 represents a standard database that contains information about a wide range of jobs. For example, the database 108 may include approximately eighty skill sets 114 associated with approximately nineteen thousand different jobs. Instead of or in addition to a standard database, the database 108 may include a customized database associated with a particular company, organization, or other employer. When a user accesses the interview support server 106 using a user device 102, the user may be required to provide a username and password. If the user wishes to access a customized database, the user may also be required to enter a code identifying the particular company, organization, or other employer associated with the customized database. In addition, the database 108 may be dynamically updatable, such as when a user adds, deletes, and modifies questions.

Although FIG. 1 illustrates one example of a system 100 for providing customized employment interviews, various changes may be made to FIG. 1. For example, the system 100 may include any number of user devices 102, networks 104, servers 106, and databases 108. Also, while FIG. 1 illustrates the use of a server 106 in the system 100, the functionality of the server 106 could be implemented on other device(s), such as a desktop computer or a laptop computer. In addition, while FIG. 1 illustrates that one database 108 is coupled directly to the interview support server 106, any number of databases 108 may reside at any location or locations accessible by the server 106.

FIG. 2 illustrates an example input screen 200 for identifying a job to be interviewed according to one embodiment of this disclosure. In particular, the input screen 200 may be displayed to a user of a user device 102 by the interview support server 106 of FIG. 1 after the user has been authenticated. The input screen 200 shown in FIG. 2 is for illustration only. Other input mechanisms may be used without departing from the scope of this disclosure.

As shown in FIG. 2, the input screen 200 includes an occupation selection box 202. The occupation selection box 202 identifies various occupations for which an employment interview may be customized. A user accessing the interview support server 106 selects an occupation listed in the occupation selection box 202. For example, the user may select an occupation from the occupation selection box 202 using a mouse or other input device. In this example, the selected occupation is displayed in bold text in the occupation selection box 202. In other embodiments, the selected occupation could be highlighted or identified in any other suitable manner.

The input screen 200 also includes a job selection box 204. The job selection box 204 identifies various jobs that are associated with the selected occupation. A user selects one of the identified jobs to customize an employment interview. For example, the user may select a job from the job selection box 204 using a mouse or other input device. In this example, the selected job is displayed in bold text in the job selection box 204. In other embodiments, the selected job could be highlighted or identified in any other suitable manner. The selected job is then displayed in a selected job box 206.

The occupations and jobs listed in FIG. 2 are for illustration only. Also, the occupations and jobs listed in FIG. 2 may vary depending on whether the user is accessing a standard database 108 or a customized database 108 (or a portion thereof). For example, if the user is accessing a standard database 108, the occupations and jobs listed in FIG. 2 may represent all possible occupations and jobs for which questions are available. If the user is accessing a custom database 108, the occupations and jobs listed in FIG. 2 may represent only those occupations and jobs related to a specific employer or group of employers.

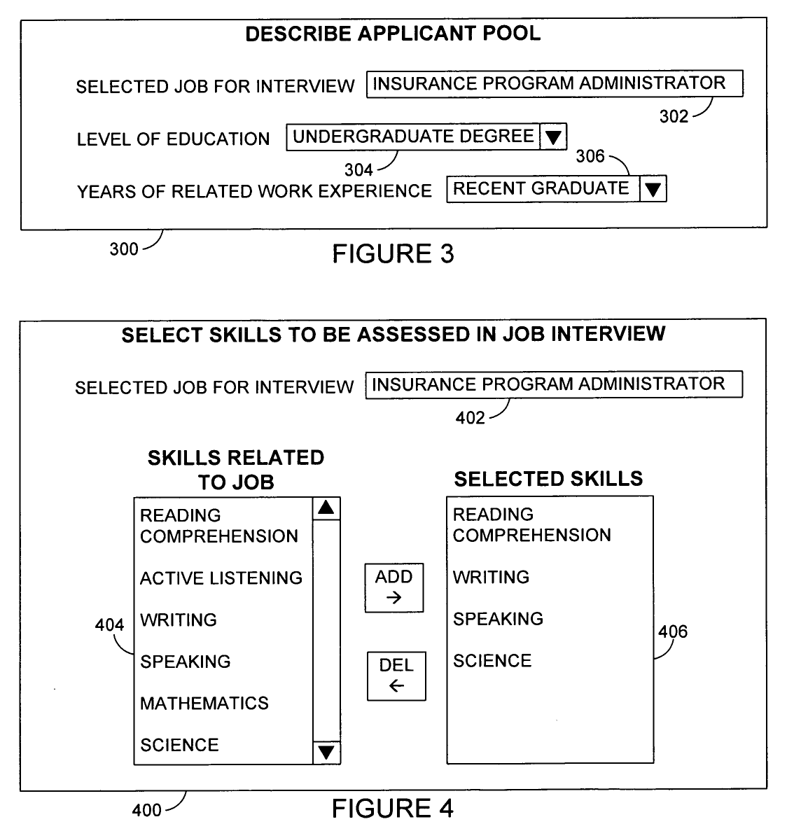

FIG. 3 illustrates an example input screen 300 for specifying applicant requirements for a job to be interviewed according to one embodiment of this disclosure. In particular, the input screen 300 may be displayed to a user of a user device 102 by the interview support server 106 of FIG. 1 after the user has completed the input screen 200 of FIG. 2. The input screen 300 shown in FIG. 3 is for illustration only. Other input mechanisms may be used without departing from the scope of this disclosure.

As shown in FIG. 3, the input screen 300 includes a selected job box 302. The selected job box 302 identifies the job selected by the user using the input screen 200 of FIG. 2. In particular, the selected job box 302 identifies the job listed in the selected job box 206 of FIG. 2.

The input screen 300 also includes an education menu 304 and an experience menu 306. The education menu 304 and the experience menu 306 allow a user to identify the desired characteristics or qualifications of job applicants to be interviewed. In general, the possible interview questions provided to a user for selection and tailoring vary based on the education and/or experience level of the job applicants. For example, questions about previous experience are not needed when a job opening involves an entry-level position.

In this example, the education menu 304 and the experience menu 306 represent drop-down menus containing options that may be selected by the user. Other mechanisms for identifying the education level and the experience of the job applicants could also be used.

FIG. 4 illustrates an example input screen 400 for identifying skills required for a job to be interviewed according to one embodiment of this disclosure. In particular, the input screen 400 may be displayed to a user of a user device 102 by the interview support server 106 of FIG. 1 after the user has completed the input screen 300 of FIG. 3. The input screen 400 shown in FIG. 4 is for illustration only. Other input mechanisms may be used without departing from the scope of this disclosure.

As shown in FIG. 4, the input screen 400 includes a selected job box 402. The input screen 400 also includes a skill selection box 404 and a selected skills box 406. The skill selection box 404 identifies various skills that are associated with the selected job to be interviewed. The skills listed in the skill selection box 404 may vary depending on the education level and/or the experience level of the job applicants.

The user selects various skills in the skill selection box 404, and the selected skills are placed into the selected skills box 406. The selected skills box 406 identifies the skills that the user believes are necessary for the job to be interviewed. In some embodiments, the user can select any number of skills. In other embodiments, the user can select only a limited number of skills, such as a maximum of eight skills.

While FIG. 4 illustrates that the skills selected by the user are shown in both the skill selection box 404 and the selected skills box 406, each skill could be shown in only one of the boxes 404-406. As an example, all skills may initially be placed in the skill selection box 404. When a skill is selected and placed in the selected skills box 406, the skill could be removed from the skill selection box 404.

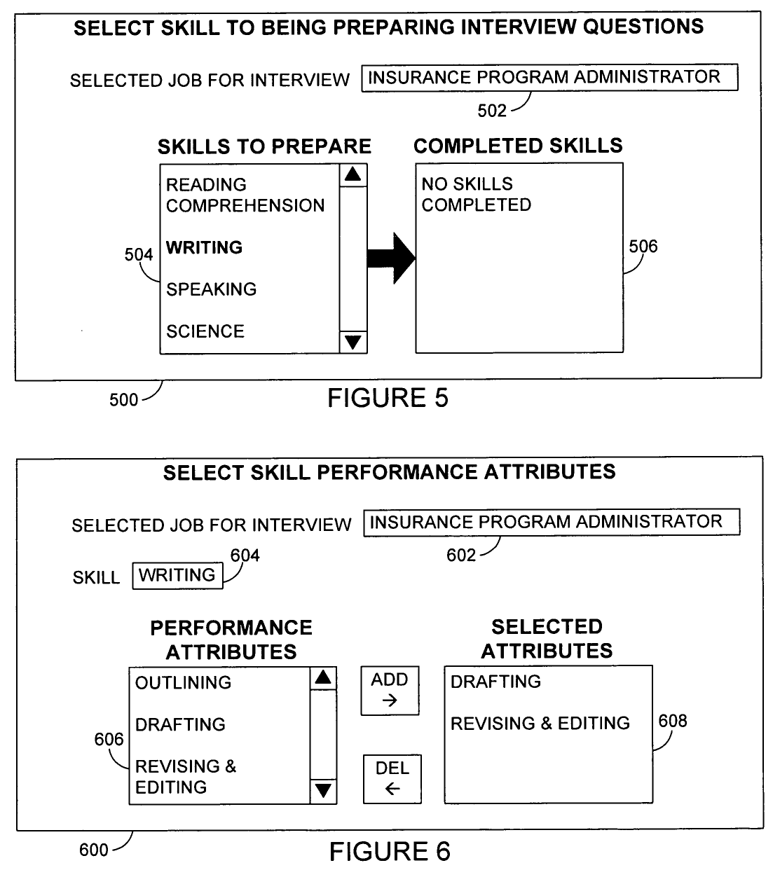

FIG. 5 illustrates an example input screen 500 for selecting an identified skill required for a job to be interviewed according to one embodiment of this disclosure. In particular, the input screen 500 may be displayed to a user of a user device 102 by the interview support server 106 of FIG. 1 after the user has completed the input screen 400 of FIG. 4. The input screen 500 shown in FIG. 5 is for illustration only. Other input mechanisms may be used without departing from the scope of this disclosure.

After the user has identified the desired or necessary skills for a job to be interviewed using the input screen 400 of FIG. 4, the user may view and select questions designed to determine whether job applicants possess these skills. In particular, the user selects each skill, selects various attributes or aspects of the skill that are important, and selects questions related to those attributes.

To begin selecting questions for a skill, the user uses the input screen 500 shown in FIG. 5 to select the skill. As shown in FIG. 5, the input screen 500 includes a selected job box 502. The input screen 500 also includes a skills selection box 504. The skills selection box 504 identifies the various skills selected by the user using the input screen 400 of FIG. 4. In particular, the skills selection box 504 initially displays the skills contained in the selected skills box 406 of FIG. 4.

The user selects one of the skills listed in the skills selection box 504. The interview selection server 106 then allows the user to choose and tailor interview questions for that selected skill. When the user has completed the selection of questions for that skill, the skill is removed from the skills selection box 504 and listed in a completed skills box 506. The completed skills box 506 identifies the skills for which questions have been selected and possibly tailored.

In this example, the completed skills box 506 is empty. At this point, the user has not chosen or tailored any interview questions for any of the skills listed in the skills selection box 504. Also, in this example, the skill that the user is preparing to choose questions for is displayed in bold text in the skills selection box 504. In other embodiments, the selected skill could be highlighted or identified in any other suitable manner.

FIG. 6 illustrates an example input screen 600 for selecting performance attributes associated with a skill required for a job to be interviewed according to one embodiment of this disclosure. In particular, the input screen 600 may be displayed to a user of a user device 102 by the interview support server 106 of FIG. 1 after the user has completed the input screen 500 of FIG. 5. The input screen 600 shown in FIG. 6 is for illustration only. Other input mechanisms may be used without departing from the scope of this disclosure.

After the user has selected a skill using the input screen 500 of FIG. 5, the user uses the input screen 600 to select various aspects of the selected skill that are desired or necessary for the job to be interviewed. As shown in FIG. 6, the input screen 600 includes a selected job box 602. The input screen 600 also includes a selected skill box 604, which identifies the skill selected using the input screen 500 of FIG. 5.

The input screen 600 further includes a performance attribute selection box 606 and a selected attributes box 608. The attribute selection box 606 identifies different aspects of the selected skill that may be chosen by the user. The attributes selected by the user are desired or necessary for the job to be interviewed. The different attributes may represent, for example, different types of activities that fall within the selected skill. Each performance attribute selected from the attribute selection box 606 is listed in the selected attributes box 608.

By allowing the user to select various aspects of a skill, the interview support server 106 may allow the user to select relevant questions for an employment interview. For example, an organization wishing to hire an employee may have policies that do not require outlines to be reviewed before a document is created. In this example, questions related to the “Outlining” aspect of the “Writing” skill may provide less valuable information to the organization during an interview.

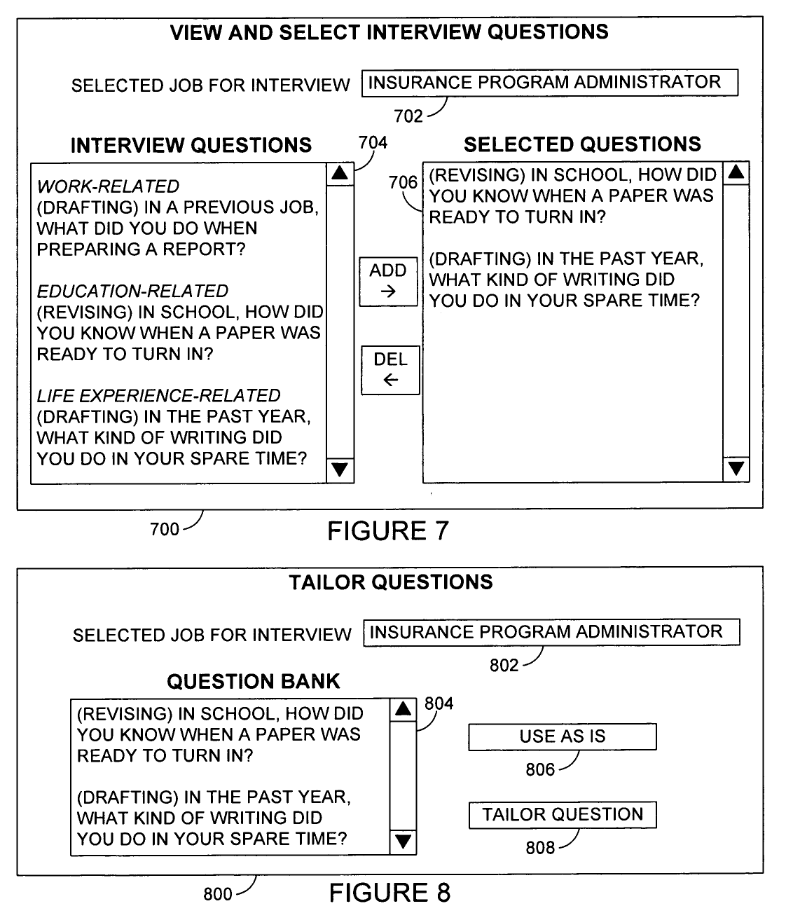

FIG. 7 illustrates an example input screen 700 for selecting questions associated with a skill required for a job to be interviewed according to one embodiment of this disclosure. In particular, the input screen 700 may be displayed to a user of a user device 102 by the interview support server 106 of FIG. 1 after the user has completed the input screen 600 of FIG. 6. The input screen 700 shown in FIG. 7 is for illustration only. Other input mechanisms may be used without departing from the scope of this disclosure.

Once a user has selected one or more performance attributes for a particular skill using the input screen 600 of FIG. 6, the user uses the input screen 700 to select interview questions. The interview questions are related to the selected performance attributes for the particular skill.

As shown in FIG. 7, the input screen 700 includes a selected job box 702. The input screen 700 also includes a question selection box 704 and a selected questions box 706. The question selection box 704 contains interview questions that could be asked during an employment interview. In particular, the question selection box 704 contains interview questions related to the specific performance attributes for a skill that were selected using the input screen 600 of FIG. 6. Each question selected from the question selection box 704 is listed in the selected questions box 706.

In the illustrated example, the questions in the question selection box 704 are divided into three groups. Some questions relate to job applicants' work experience, other questions relate to job applicants' education, and still other questions relate to job applicants' life experiences. Other or additional types of questions could be used.

In some embodiments, the user can select any number of questions from the question selection box 704. In other embodiments, the user can select only a limited number of questions, such as a maximum of three questions.

While FIG. 7 illustrates that the selected questions are shown in both the question selection box 704 and the selected questions box 706, each question could be shown in only one of the boxes 704-706. As an example, all questions may initially be placed in the question selection box 704. When a question is selected and placed in the selected questions box 706, the skill could be removed from the question selection box 704.

FIG. 8 illustrates an example input screen 800 for customizing questions associated with a skill required for a job to be interviewed according to one embodiment of this disclosure. In particular, the input screen 800 may be displayed to a user of a user device 102 by the interview support server 106 of FIG. 1 after the user has completed the input screen 700 of FIG. 7. The input screen 800 shown in FIG. 8 is for illustration only. Other input mechanisms may be used without departing from the scope of this disclosure.

After a user has selected one or more questions using the input screen 700 of FIG. 7, the user is given the option of customizing or tailoring the selected questions or using the questions “as is.” As shown in FIG. 8, the input screen 800 includes a selected job box 802 and a selected questions box 804. The selected questions box 804 identifies the question or questions selected by the user using the input screen 700 of FIG. 7.

The input screen 800 further includes a “Use As Is” button 806 and a “Tailor Question” button 808. For each question in the selected questions box 804, the user can use the buttons 806-808 to indicate whether the question should be used as is during an interview or be modified. If the user indicates that a question is to be used as is, the question may be used as it currently stands during an interview. If the user indicates that a question is to be tailored, the user is given the option of revising the question, and the revised question may be used during an interview.

Once the user decides that the questions (as is or as revised) are suitable for use, the user indicates that the questions for a particular skill have been completed. At that point, the skill is listed in the completed skills box 506 in the input screen 500 of FIG. 5. If questions for additional skills are needed, the user may use input screens 500-800 to select another skill and repeat the question selection process.

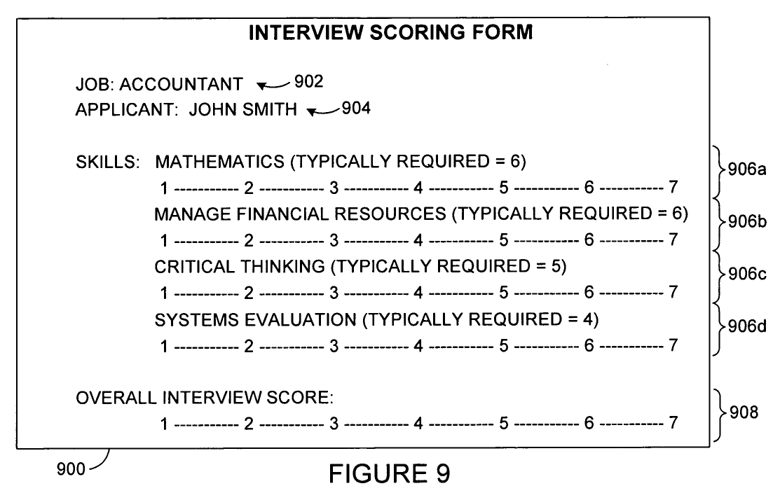

Otherwise, if questions for all skills have been selected, the interview support server 106 could give the user an option to print various forms for an interview. For example, the user could select an option to print a questionnaire containing the selected questions. A summary or cover sheet for the questionnaire could identify the selected skills to be assessed during an interview and identify which questions correspond to each selected skill. An interviewer may then use the printed questionnaire to conduct employment interviews. In addition, the user could select an option to print a scoring sheet allowing an interviewer to score a job applicant during an interview. An example scoring sheet is shown in FIG. 9, which is described below.

In some embodiments, the occupations, jobs, skills, and performance attributes used in the system 100 are defined by the Occupation Information Network (O*NET) standard. Other standards or mechanisms for defining and associating occupations, jobs, skills, and performance attributes may be used without departing from the scope of this disclosure.

Although FIGS. 2-8 illustrate examples of input screens 200-800 used to collect various information to generate an employment interview, various changes may be made to FIGS. 2-8. For example, any other input screens or other mechanisms could be used to collect the various information. Also, these examples illustrate that interview questions are selected based on the occupation, job, skills, and performance attributes. In other embodiments, the interview support server 106 could use a task-based approach to provide employment interviews. In the task-based approach, the interview support server 106 provides different possible interview questions based on the tasks to be performed by a job applicant. In addition, each of the input screens 200-800 could include any other or additional content. As an example, each input screen 200-800 could include a “Continue” button allowing the user to continue the interview production process and a “Help” button for providing advice to the user.

FIG. 9 illustrates an example scoring sheet 900 for scoring an interview candidate according to one embodiment of this disclosure. The scoring sheet 900 shown in FIG. 9 is for illustration only. Other scoring sheets may be used without departing from the scope of this disclosure.

The scoring sheet 900 allows an interviewer to score or rank a job applicant. In particular, the scoring sheet 900 allows an interviewer to score or rank a job applicant in terms of the various skills used to generate an employment interview.

As shown in FIG. 9, the scoring sheet 900 includes a job identifier 902 and an applicant identifier 904. The job identifier 902 identifies the job for which an interview is conducted, and the applicant identifier 904 identifies an applicant being interviewed for that job.

The scoring sheet 900 also includes a plurality of skill scoring sections 906a-906d. Each of the skill scoring sections 906a-906d identifies a skill for which interview questions were selected and a typical score needed for that skill. Each of the skill scoring sections 906a-906d also includes a numeric range, which allows an interviewer to identify a job applicant's score for a particular skill.

In addition, the scoring sheet 900 includes an overall score section 908. This allows an interviewer to indicate an overall score for a job applicant.

The scoring sheet 900 shown in FIG. 9 could represent a printed form that can be used during an interview. The scoring sheet 900 could also represent an input screen used to provide scoring data to the interview support server 106. The interview support server 106 could use the provided scores to perform any suitable function, such as averaging the interview scores from multiple interviewers and ranking job applicants by score.

Although FIG. 9 illustrates one example of a scoring sheet 900 for scoring an interview candidate, various changes may be made to FIG. 9. For example, the scoring sheet 900 could have any other format and/or layout. The scoring sheet 900 could also include any other or additional information for scoring or otherwise identifying a job applicant's performance during an interview.

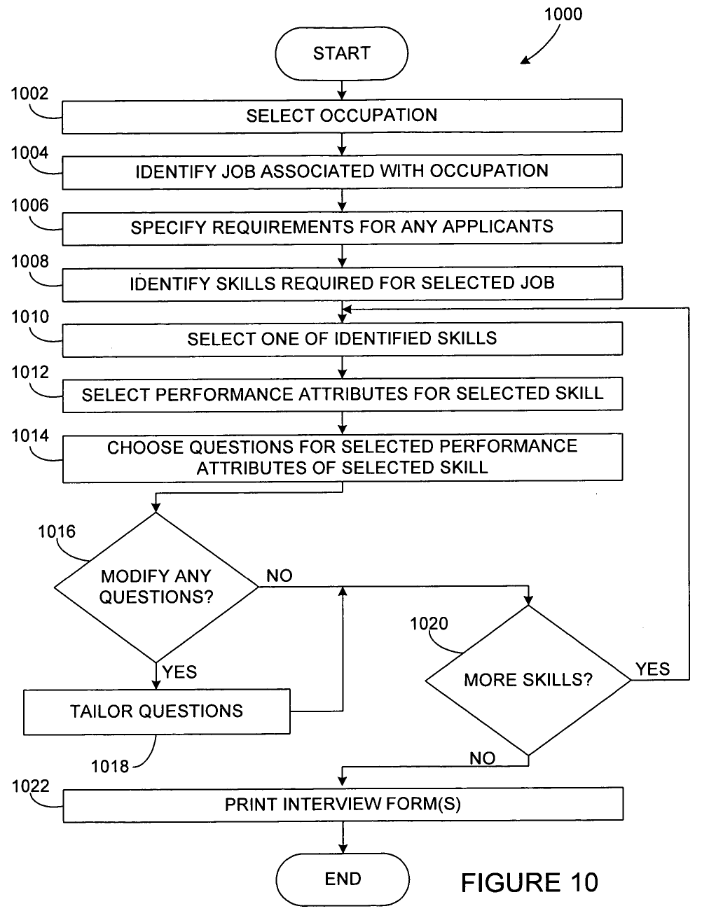

FIG. 10 illustrates an example method 1000 for providing customized employment interviews according to one embodiment of this disclosure. For ease of explanation, the method 1000 is described with respect to the interview support server 106 operating in the system 100 of FIG. 1. The method 1000 could be used by any other suitable device and in any other suitable system.

The interview support server 106 allows a user to select an occupation at step 1002. This may include, for example, the interview support server 106 providing the user with a list of possible occupations. The list of occupations may represent a standard list of all possible occupations or a customized list, such as for a particular employer or group of employers. The occupations presented to the user may be based on information provided by the user during an authentication process. As an example, the user could be authorized to view only a list of all occupations and not authorized to view a customized list of occupations.

The interview support server 106 allows a user to identify a job at step 1004. This may include, for example, the interview support server 106 providing the user with a list of jobs associated with the selected occupation. The list of jobs may represent a standard or customized list. Also, the list of jobs presented to the user may be based on information provided by the user during the authentication process.

The interview support server 106 allows a user to specify requirements for potential job applicants at step 1006. This may include, for example, the interview support server 106 allowing the user to identify an education level and an experience level that job applicants should possess.

The interview support server 106 allows a user to identify one or more skills required for the selected job at step 1008. This may include, for example, the interview support server 106 providing the user with a list of skills typically associated with the selected job. The list of skills may represent a standard or customized list. Also, the list of skills may or may not be based on the education level, experience level, or other requirements associated with the selected job.

The interview support server 106 allows the user to select one of the identified skills at step 1010. This may include, for example, the interview support server 106 presenting a list of the skills that the user identified during the previous step.

The interview support server 106 allows the user to select one or more performance attributes associated with the selected skill at step 1012. This may include, for example, the interview support server 106 providing a standard or customized list of performance attributes to the user. Also, the list of performance attributes may or may not be based on the education level, experience level, or other requirements associated with the selected job.

The interview support server 106 allows a user to choose one or more questions associated with the selected performance attributes at step 1014. This may include, for example, the interview support server 106 providing a standard or customized list of questions to the user. The questions may relate generally to the selected skill and more specifically to one or more of the selected performance attributes.

The interview support server 106 determines whether the user wishes to modify or tailor any of the chosen questions at step 1016. If so, the interview support server 106 allows the user to tailor one or more of the chosen questions at step 1018. This may include, for example, the interview support server 106 allowing the user to edit a question in a text editor or in any other suitable manner.

The interview support server 106 determines whether the user needs to select questions for other skills related to the selected job at step 1020. If so, the interview support server 106 returns to step 1010 and allows the user to select another skill. Otherwise, the interview support server 106 allows the user to print one or more interview forms at step 1022. This may include, for example, the interview support server 106 allowing a user to print an interview questionnaire containing the selected questions. This may also include the interview support server 106 allowing the user to print one or more scoring sheets to be used during interviews.

Although FIG. 10 illustrates one example of a method 1000 for providing customized employment interviews, various changes may be made to FIG. 10. For example, FIG. 10 illustrates that all of the interview questions are selected before an interview is conducted. In other embodiments, the interview questions could be selected dynamically during an interview. As a particular example, a user using a user device 102 could provide scores to the interview support server 106 during an interview. The interview support server 106 could then use the scores to dynamically select additional questions, which may be relayed to the user through the user device 102.

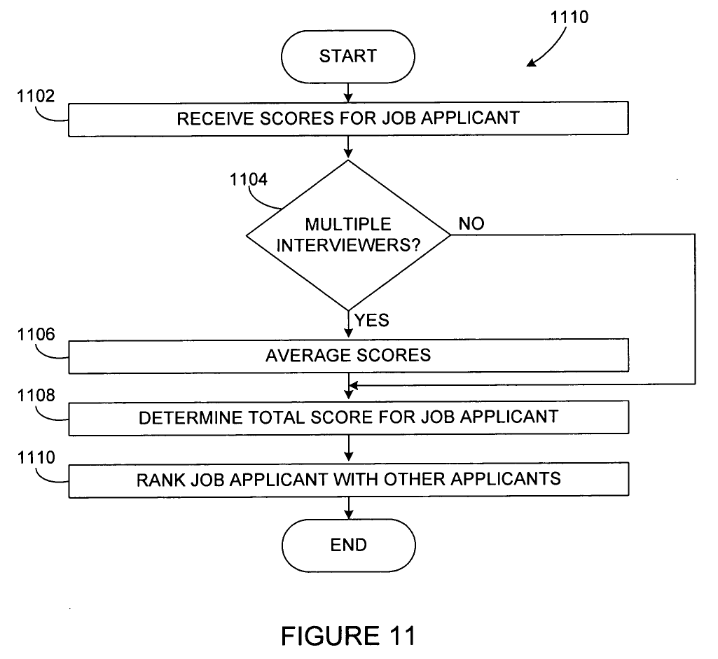

FIG. 11 illustrates an example method 1100 for scoring an interview candidate according to one embodiment of this disclosure. For ease of explanation, the method 1100 is described with respect to the interview support server 106 operating in the system 100 of FIG. 1. The method 1100 could be used by any other suitable device and in any other suitable system.

The interview support server 106 receives one or more scores for a job applicant at step 1102. This may include, for example, the interview support server 106 receiving individual scores for various skills and an overall score for the job applicant. This may also include the interview support server 106 receiving scores from one or multiple interviewers.

The interview support server 106 determines whether scores from multiple interviewers were received at step 1104. If so, the interview support server 106 averages the scores at step 1106. This may include, for example, the interview support server 106 averaging the scores for each skill and averaging the overall scores.

The interview support server 106 determines a total score for the job applicant at step 1108. The interview support server 106 may use any suitable technique to identify a total score for an applicant. For example, the interview support server 106 could average all scores for the various skills and then average that value with the average overall score. The interview support server 106 could also use weights associated with the skill scores and the overall score to generate a total score.

The interview support server 106 ranks the job applicant with other applicants at step 1110. This may include, for example, the interview support server 106 using the total score of the applicants to rank them.

Although FIG. 11 illustrates one example of a method 1100 for scoring an interview candidate, various changes may be made to FIG. 11. For example, the interview support server 106 could rank the job applicants without determining a total score for each applicant at step 1108. As a particular example, the interview support server 106 could provide multiple rankings, one ranking for each skill and one ranking for overall score. Also, the interview support server 106 could perform any other actions using the interview scores and need not only rank the job applicants. As an example, the interview support server 106 could allow a user to print summaries of the scores for one or multiple interviews.

It may be advantageous to set forth definitions of certain words and phrases that have been used within this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, software, firmware, or combination thereof. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
receiving an identification of one or more skills associated with a job;
providing one or more questions associated with the one or more skills;
receiving a selection of at least one of the questions; and
providing an interview form comprising the at least one selected question for use during an employment interview.

2. The method of claim 1, further comprising receiving an identification of the job by:
providing a list of occupations to a user;
receiving a selection of one of the occupations from the user;
providing a list of jobs associated with the selected occupation to the user; and
receiving a selection of one of the jobs from the user.

3. The method of claim 1, wherein receiving the identification of the one or more skills comprises:
providing a list of skills to a user; and
receiving a selection of one or more of the skills from the user.

4. The method of claim 1, further comprising receiving an identification of one or more performance attributes associated with the one or more identified skills; and
wherein providing the plurality of questions comprises providing a plurality of questions associated with the one or more identified performance attributes.

5. The method of claim 1, wherein providing the plurality of questions comprises providing a list of questions to a user, the list of questions comprising one or more of: work-related questions, education-related questions, and life experience-related questions.

6. The method of claim 1, further comprising allowing a user to tailor one or more of the selected questions.

7. The method of claim 1, wherein the interview form comprises a questionnaire.

8. The method of claim 1, further comprising receiving one or more scores associated with the employment interview.

9. A system, comprising:
a memory operable to store a plurality of questions; and
one or more processors collectively operable to:
receive an identification of one or more skills associated with a job;
receive a selection of at least one of the questions, the at least one selected question associated with the one or more skills; and
provide an interview form comprising the at least one selected question for use during an employment interview.

10. The system of claim 9, wherein the one or more processors are further collectively operable to receive an identification of the job by:
providing a list of occupations to a user;
receiving a selection of one of the occupations from the user;
providing a list of jobs associated with the selected occupation to the user; and
receiving a selection of one of the jobs from the user.

11. The system of claim 9, wherein the one or more processors are collectively operable to receive the identification of the one or more skills by:
providing a list of skills to a user; and
receiving a selection of one or more of the skills from the user.

12. The system of claim 9, wherein the one or more processors are further collectively operable to:
receive an identification of one or more performance attributes associated with the one or more identified skills; and
provide a plurality of questions associated with the one or more identified performance attributes for selection.

13. The system of claim 12, wherein the plurality of questions comprise one or more of: work-related questions, education-related questions, and life experience-related questions.

14. The system of claim 9, wherein the one or more processors are further collectively operable to allow a user to tailor one or more of the selected questions.

15. A computer program embodied on a computer readable medium and operable to be executed by a processor, the computer program comprising computer readable program code for:
receiving an identification of one or more skills associated with a job;
receiving a selection of one or more questions associated with the one or more skills; and
providing an interview form comprising the one or more selected questions for use during an employment interview.

16. The computer program of claim 15, further comprising computer readable program code for receiving an identification of the job by:
providing a list of occupations to a user;
receiving a selection of one of the occupations from the user;
providing a list of jobs associated with the selected occupation to the user; and
receiving a selection of one of the jobs from the user.

17. The computer program of claim 15, wherein the computer readable program code for receiving the identification of the one or more skills comprises computer readable program code for:
providing a list of skills to a user; and
receiving a selection of one or more of the skills from the user.

18. The computer program of claim 15, further comprising computer readable program code for:
receiving an identification of one or more performance attributes associated with the one or more identified skills; and
providing a plurality of questions associated with the one or more identified performance attributes for selection.

19. The computer program of claim 18, wherein the plurality of questions comprise one or more of: work-related questions, education-related questions, and life experience-related questions.

20. The computer program of claim 15, further comprising computer readable program code for allowing a user to tailor one or more of the selected questions.

21. A method, comprising:
identifying one or more skills associated with a job;
receiving one or more questions associated with the one or more skills;
selecting at least one of the questions; and
receiving an interview form comprising the at least one selected question for use during an employment interview.

22. The method of claim 21, further comprising:
receiving a list of occupations;
selecting one of the occupations;
receiving a list of jobs associated with the selected occupation; and
selecting one of the jobs.

23. The method of claim 21, further comprising tailoring one or more of the selected questions.
